(19) United States
(12) Patent Application Publication
(10) Pub. No.: US 2010/0192380 A1
(43) Pub. Date: Aug. 5, 2010

(54) KNIFE AND DEVICE ASSEMBLY ENABLING ITS TRANSFORMATION AND ITS USE AS HAND TOOL

(75) Inventor: Edouard DE BUYER-MIMEURE, Bourges (FR)

Correspondence Address: HESLIN ROTHENBERG FARLEY & MESITI PC, 5 COLUMBIA CIRCLE, ALBANY, NY, 12203, US

(73) Assignee: WILDSTEER, Bourges (FR)

(21) Appl. No.: 12/695,527

(22) Filed: Jan. 28, 2010

(30) Foreign Application Priority Data
Feb. 4, 2009 (FR) 0950677

(51) Int. Cl. B26B 11/00

(52) U.S. Cl. 30/146

(57) ABSTRACT

A knife and device assembly includes a knife with a blade part and a handle part having on the blade part, near the handle part, a hook shaped part with an interior recess, in combination with a device comprising an extended handle. A front end of the handle has both a pin for engaging with and pivoting in the hook shaped part of the blade part, and a cutting element to cut metal wires and the like. The handle fulfills the function of cutting pliers with the handle part of the knife. The front end of the handle has a fork shape with two wings braced by the pin. The cutting element is received in a space formed between the wings, the pin and a bottom of the fork shape, and has a cutting part projecting beyond the handle.

### CROSS REFERENCE TO RELATED APPLICATIONS

This application claims priority of French application FR 0950677 filed on Feb. 4, 2009, the entire contents of which is hereby incorporated by reference herein.

### BACKGROUND ART

This invention relates to the technical sector of cutlery, and more particularly to multi-function knives.

Known for a long time, these types of knives are based on a single body designed to receive different types of blades and/or accessories such as scissors and corkscrews, offering the user a multiplicity of functions. The typical example is that of the knife known by the commercial name of “Swiss Army Knife” which may be larger or smaller depending on the number of accessories or blades stored.

This type of knife is generally used when trekking, camping and, in certain cases, in survival situations.

The functions are nevertheless limited, because the necessarily limited storage space of the body of the knife must be taken into account, otherwise the body would be excessively bulky and heavy.

In the case of certain variations, some so-called “Swiss Army Knives” are even designed in the form of pliers having in the branches of the handle specific arrangements to receive multi-function tools in the form of blades, scissors and suchlike.

Furthermore, and to the knowledge of the Applicant, some functions are not provided and possible on this type of knife, for example the cutting of metal wires that may be several millimetres in diameter. This scissor part known on so-called “Swiss Army Knives” is limited in its capacity to cut and/or shear.

Document US 2003/0101590 discloses a knife of complicated design that transforms into cutting pliers.

Other devices of the same type described in patents DE 9315843 and DE 3715440 are also known.

The Applicant's approach has therefore been to devise a new design of knife unlike the so-called “Swiss Army Knives” to fulfil new functions and be used as a proper hand tool.

The solution proposed by the Applicant is simple, inexpensive, has no impact on the configuration of the knife and its volume.

### BRIEF SUMMARY OF THE INVENTION

According to a first characteristic of the invention, the knife and device assembly includes a knife with a blade part and a handle part having on the blade part, near the handle part, a hook shaped part with a deep bottom part (interior recess), in combination with a device comprising an extended handle whose front end has both an articulation pin for engaging with and pivoting in the hook part of the blade part, and cutting means to cut metal wires and suchlike, the handle fulfilling the function of cutting pliers with the handle part of the knife itself The front end of the handle has a fork shape with two wings braced by the articulation pin. A space formed between the wings, the pin and the bottom of the fork shape receives the cutting means. The cutting means has a cutting part projecting beyond the handle.

These and other characteristics will emerge more clearly from the following description.

### BRIEF DESCRIPTION OF THE DRAWING FIGURES

The object of the invention is illustrated in a non-limiting way in the accompanying drawings, in which:

FIG. 1 is a perspective view before assembly of the knife and the device according to the invention.

FIG. 2 is a view of the knife with the device fitted.

FIG. 3 is a sectional view along line 3-3 in FIG. 2.

FIG. 4 is a variation of the device according to the invention.

FIG. 5 shows the use of the knife and the associated device for cutting wires.

### DETAILED DESCRIPTION

For a better understanding of the object of the invention, a non-limiting description thereof now follows, as illustrated in the figures.

The knife including the device according to the invention is designated as a whole by the reference (C) and comprises a blade part (C1) and a handle part (C2). To enable the implementation of the invention, the blade part, near the handle part, has a curved hook shaped part (1) with a deep bottom part or interior recess (1a). The device according to the invention is numbered (2) and comprises a very long or extended handle one of the ends of which (2a) is designed to receive a pin (3) capable of engaging with and pivoting in the hook part of the blade on the one part and is designed to receive cutting means (4) designed to cut metal wires (F) and suchlike on the other part, this handle fulfilling the function of cutting pliers with the handle part of the knife itself.

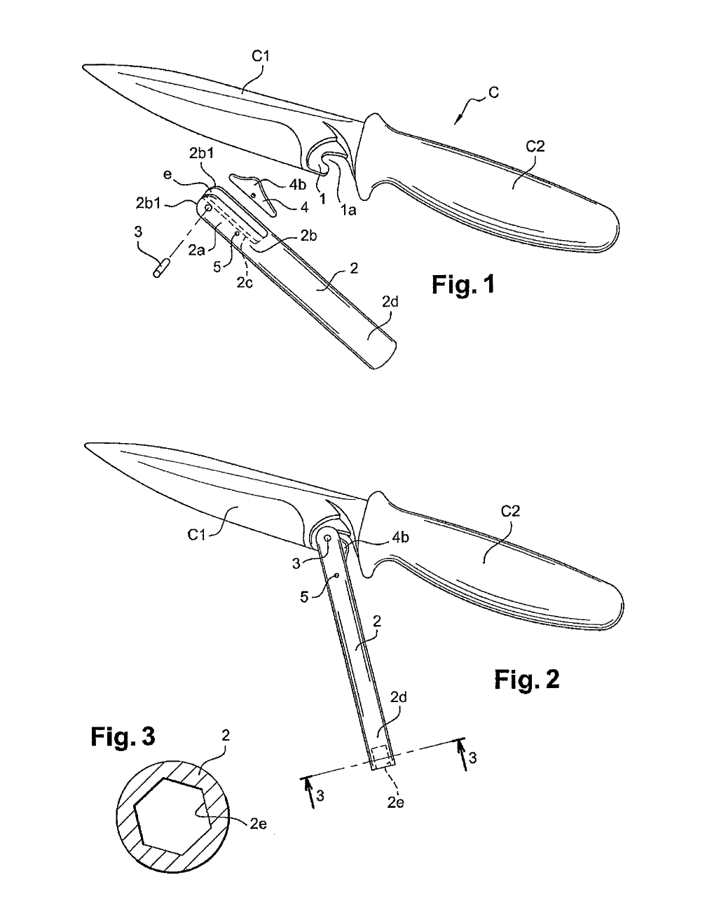

With reference to the drawings, the very long handle (2) has a fork shape (2b) at its front end (2a) with two wings (2b1) braced by the articulation pin (3). The space (e) formed between the said wings, the pin (3) and the bottom of the fork shape enables the cuttings means (4) to be received. The latter may be arranged as shown in FIG. 1 by a piece shaped like a tricorn hat (4a) with a cutting part (4b) that protrudes and can therefore be sharpened as required. This piece is secured by a rivet (5) between the wings of the fork shape (2b). It is advantageously supported by a mounting (2c) which constitutes a counter-brace to absorb the cutting forces.

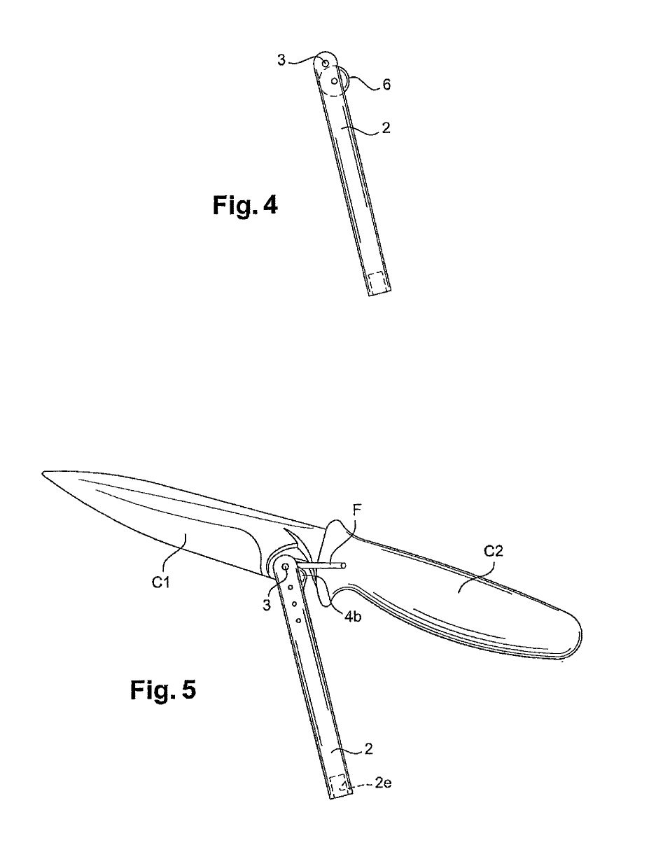

The said cutting piece (4) may be fitted in a fixed or removable manner. In the variation shown in FIG. 4, the said cutting piece is made in the form of a cutting wheel (6).

With reference to FIG. 5, the articulation of the handle (2) in relation to the handle part (C2) of the knife will enable wire-shaped elements like metal wires or suchlike to be held and cut.

According to another embodiment of the invention, the other end (2d) of the handle (2) may be designed internally so as to have a useful shape, such as a thread or threaded portion, or to have a polygon shape (2e) to enable the knife to be used as a screwing or unscrewing tool. The polygon shape is suitable for receiving similarly shaped tool modules.

The advantages of the invention are clear. Emphasis is given to the practical aspect of the knife and its device, the easy storage facilities that it offers and the possibility of using the knife as a screwing/unscrewing hand tool, a screwdriver or other tool.

Furthermore, and compared to the prior art of so-called “Swiss Army Knives”, the invention enables metal wires to be cut with a much greater pressure force, cutting wires of several millimetres in diameter.

1) Knife and device assembly comprising a knife with a blade part and a handle part having on the blade part, near the handle part, a hook shaped part with an interior recess, in combination with a device comprising an extended handle, a front end of the handle having both an articulation pin for engaging with and pivoting in the hook shaped part of the blade part and cutting means to cut metal wires and the like, the handle fulfilling the function of cutting pliers with the handle part of the knife, and wherein the front end of the handle has a fork shape with two wings braced by the articulation pin, a space formed between the two wings, the pin and a bottom of the fork shape receiving the cutting means, and wherein the cutting means has a cutting part projecting beyond the handle.

2) Knife and device assembly according to claim 1, wherein the cutting means comprises a piece shaped like a tricorn hat with a cutting part that protrudes and can therefore be sharpened.

3) Knife and device assembly according to claim 2, wherein the piece is secured by a rivet between the wings of the fork shape.

4) Knife and device assembly according to claim 2, wherein the cutting means is supported by a mounting that constitutes a counter-brace to absorb cutting forces.

5) Knife and device assembly according to claim 1, wherein the cutting means comprises a cutting wheel.

6) Knife and device assembly according to claim 1, wherein an other end of the handle is configured internally so as to have a useful shape.

7) Knife and device assembly according to claim 6, wherein the useful shape comprises a threaded portion.

8) Knife and device assembly according to claim 6, wherein the useful shape comprises a polygon shape to enable the knife to be used as a screwing or unscrewing tool.
